(19) United States
(12) Patent Application Publication
(10) Pub. No.: US 2011/0142153 A1
(43) Pub. Date: Jun. 16, 2011

(54) MULTIPLE-INPUT MULTIPLE-OUTPUT SYSTEM, RECEIVING APPARATUS AND METHOD OF RECEIVING SIGNALS

(75) Inventors: Chan-Ho Yoon, Daejeon-si (KR); Woo-Yong Lee, Daejeon-si (KR); Hyun-Kyu Chung, Daejeon-si (KR)

(73) Assignee: Electronics and Telecommunications Research Institute, Daejeon-si (KR)

(21) Appl. No.: 12/965,613

(22) Filed: Dec. 10, 2010

(30) Foreign Application Priority Data
Dec. 15, 2009 (KR) 10-2009-0125132
Apr. 19, 2010 (KR) 10-2010-0036029

(51) Int. Cl. H04B 7/02; H04L 27/06

(52) U.S. Cl. 375/267; 375/340; 375/341

(57) ABSTRACT

A multi-input multi-output system, receiving apparatus and method of receiving signals are provided. The multi-input multi-output system includes a transmitting apparatus configured to send signals coded through a double space time transmit diversity scheme while changing a phase and an antenna, and a receiving apparatus configured to, if a signal is received from the transmitting apparatus, estimate predetermined symbols by use of a maximum likelihood estimation scheme, estimate remaining symbols by use of a decision feedback equalization scheme, and to calculate a Log Likelihood Ratio (LLR) of each of the predetermined symbols and the remaining symbols, in which the LLR of the remaining symbol is calculated by switching a channel matrix vector (H) of the receiving signal.

### CROSS-REFERENCE TO RELATED APPLICATION

This application claims the benefit under 35 U.S.C. §119(a) of Korean Patent Application No. 10-2009-0125132, filed on Dec. 15, 2009, and No. 10-2010-0036029, filed on Apr. 19, 2010, the disclosures of which are incorporated by reference in its entirety for all purposes.

### BACKGROUND

1. Field

The following description relates to a wireless communication technology, and more particularly, to a technology of detecting signals in a multiple-input multiple-output system having a multiple antenna.

2. Description of the Related Art

A multiple-input multiple-output (MIMO) system forms a plurality of independent fading channels by using a multiple antenna at a sending end and a receiving end, and transmits a different signal from each sending antenna, thereby significantly improving data transfer rate.

However, the MIMO system is too fragile in light of inter-symbol interference in a high speed data transfer and frequency selective fading. In order to overcome this shortcoming, an orthogonal frequency division multiplexing (OFDM) scheme may be applied to the MIMO system. The OFDM scheme is a proper modulation scheme for transmitting data at a high speed, and transmits one data row through a subcarrier having a lower data transfer rate.

By combining an OFDM system with a MIMO system, the advantages of the MIMO system are maintained while the disadvantages of the MIMO system are reduced by use of the OFDM system. In general, a MIMO-OFDM system has a configuration in which an OFDM system is applied to a MIMO system having N sending antennas and N receiving antennas.

### SUMMARY

In one aspect, there is provided a MIMO-OFDM wireless communication technology providing reduced implementation complexity.

In one general aspect, there is provided a receiving apparatus for signals using a multiple antenna in a wireless communication environment. The receiving apparatus includes a QR decomposition unit, a first estimation unit, and a second estimation unit. The QR decomposition unit is configured to convert a receiving signal into a receiving vector and decompose a channel matrix vector (H) of the receiving vector into a unitary matrix vector (Q) and an upper triangle matrix vector (R). The first estimation unit is configured to estimate predetermined symbols by use of the unitary matrix vector (Q) and the upper triangle matrix vector (R) and to calculate a Log Likelihood Ratio (LLR) of the estimated predetermined symbols. The second estimation unit is configured to estimate remaining symbols other than the predetermined symbols by use of a decision feedback equalization scheme and to calculate a Log Likelihood Ratio (LLR) of the estimated remaining symbols by switching the channel matrix vector (H) into a channel matrix vector (H_{sw}).

In another general aspect, there is provided an apparatus for receiving signals by use of a multiple antenna in a wireless communication environment. The apparatus includes a multi-input multi-output receiving unit and a decoding unit. The multi-input multi-output receiving unit is configured to estimate predetermined symbols by use of a maximum likelihood estimation scheme, estimate remaining symbols by use of a decision feedback equalization scheme, calculates a Log Likelihood Ratio (LLR) of each of the predetermined symbols and the remaining symbols, in which the LLR of the remaining symbol is calculated by switching a channel matrix vector (H) of the receiving signal. The decoding unit is configured to decode the estimated predetermined symbol and the remaining symbol.

In another general aspect, there is provided a multi-input multi-output system. The multi-input multi-output system includes a transmitting apparatus and a receiving apparatus. The transmitting apparatus is configured to send signals coded through a double space time transmit diversity scheme while changing a phase and an antenna. The receiving apparatus is configured to, if a signal is received from the transmitting apparatus, estimate predetermined symbols by use of a maximum likelihood estimation scheme, estimate remaining symbols by use of a decision feedback equalization scheme, and to calculate a Log Likelihood Ratio (LLR) of each of the predetermined symbols and the remaining symbols, in which the LLR of the remaining symbol is calculated by switching a channel matrix vector (H) of the receiving signal.

In another general aspect, there is provided a method of receiving signals by use of a multiple antenna in a wireless communication environment. The method is as follows. A receiving signal is converted into a receiving vector and decomposing a channel matrix vector (H) of the receiving vector into a unitary matrix vector (Q) and an upper triangle matrix vector (R). Predetermined symbols are estimated by use of the unitary matrix vector (Q) and the upper triangle matrix vector (R). A Log Likelihood Ratio (LLR) of the estimated predetermined symbols is calculated. Remaining symbols other than the predetermined symbols are estimated by use of a decision feedback equalization scheme. A Log Likelihood Ratio (LLR) of the estimated remaining symbols is calculated by changing the channel matrix vector (H).

According to the present invention, a receiving apparatus having reduced implementation complexity and improved data transfer rate is provided by applying a Maximum Likelihood-Decision Feedback Equalizer (ML-DFE) scheme to a Dual Space time block coded-orthogonal frequency division multiplexing (STBC-OFDM) system.

In particular, a STBC-OFDM based signal receiving method provides improved signal transfer rate and link level performance in the case where the number of sending antennas exceeds the number of the receiving antennas. In addition, implementation complexity of the receiving apparatus is reduced through the dual STBC-OFDM based signal receiving method, thereby facilitating implementation of a high performance signal receiving apparatus.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 shows a configuration of an example of a transmitting apparatus of a multiple-input multiple-output system.

FIG. 2 shows a configuration of an example of a receiving apparatus of a multiple-input multiple-output system.

FIG. 3 shows a detailed configuration of a multiple-input multiple-output receiving unit shown in FIG. 2.

FIG. 4 shows a control flow of an example of a method of receiving signals.

FIG. 5 shows a result of a link level simulation made when an example of a dual STBC-OFDM is used based on IEEE 802-11a Wireless Local Area Network (WLAN) standard.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, examples will be described in detail with reference to accompanying drawings.

A multiple-input multiple-output (MIMO) system according to the present invention is a system which transmits and receives signals in a wireless communication environment by use of a multiple antenna. In particular, an orthogonal frequency division multiplexing (OFDM) is combined to the MIMO system. In addition, a dual Space Time Block Coded (STBC) scheme is also applied to the MIMO system. That is, the MIMO system according to the present invention employs a spatial multiplexing technology and a space time coding technology.

The MIMO system uses a non-linear transmission/reception scheme. A typical non-linear receiver conveys complexity in spite of superior receiving performance, causing a difficulty in implementation. However, the MIMO system according to the present invention provides the same performance and reduced implementation complexity with a non-linear reception scheme.

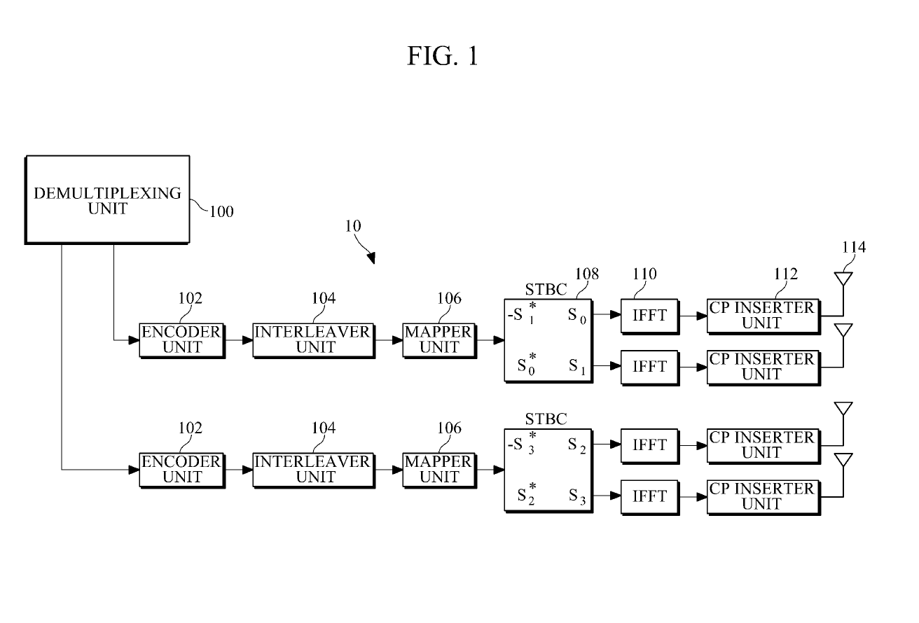

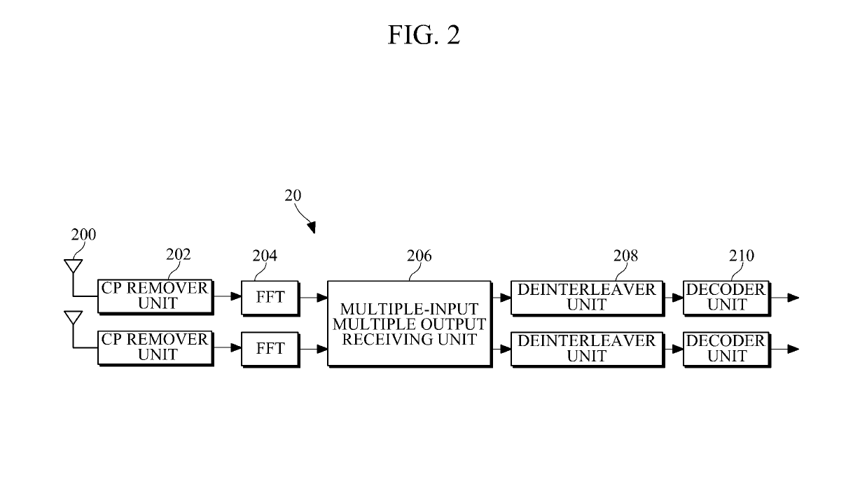

In particular, the according to the present invention includes more transmitting antennas of a transmitting apparatus than antennas of a receiving apparatus. As shown in FIG. 1, the transmitting apparatus 10 uses four transmitting antennas, and as shown in FIG. 2, the receiving apparatus 20 uses two transmitting antennas. According to the present invention, when the sending antennas are more than the receiving antennas, high data transfer rate and superior link level performance are guaranteed. In addition, the receiving apparatus 20 achieves superior reception performance through a low implementation complexity.

Hereinafter, the transmitting apparatus 10 and the receiving apparatus 20 of the MIMO system will be described in detail with reference to FIGS. 1 and 2.

FIG. 1 shows a configuration of an example of a transmitting apparatus of a multiple-input multiple-output system.

As shown in FIG. 1, the transmitting apparatus 10 includes a demultiplexing unit 100, an encoder unit 102, an interleaver unit 104, a mapper unit 106, a Space Time Block Coding (STBC) unit 108, an Inverse Fourier Transform (IFFT) unit (110), a Cyclic Prefix (CP) inserter unit 112, and multiple transmitting antennas 114.

The demultiplexing unit 100 divides a transmit bit stream into a plurality of data rows for a channel encoding. The encoder unit 102 encodes corresponding input data. The encoded data are interleaved by the interleaver unit 104 and input into the mapper unit 106. The interleaving is to spread error burst of frequency selective signals. The mapper unit 106 modulates the interleaved data according to a modulation scheme, for example, Binary Phase Shift Keying (BPSK), Quadrature Phase Shift Keying (QPSK), 16 Quarature Amplitude Modulation (16QAM) and 64 Quarature Amplitude Modulation (64QAM). The STBC unit 108 performs a space-time transmit diversity coding, introduced by Alamouti, in a frequency domain.

The IFFT unit 110 transforms the respective signals coded in the STBC 108 into signals in a time domain. The CP inserter unit 112 inserts a CP code for a guard interval into the transformed symbols. The CP code refers to the end of an IFFT symbol. The CP inserted signal is converted to parallel signals, and the signals are transmitted to multiple receiving apparatus 200 by the multiple transmitting antenna 114 over a wireless channel.

Hereinafter, transmitting signals transmitted through the transmitting apparatus 10 will be described with reference to the following equation. As shown in FIG. 1, the transmitting apparatus 10 uses four transmitting antennas 114. The space-time transmit diversity coding process in a time domain is expressed as per equation 1.

$$x ( n , n + 1 ) = [ \begin{matrix}{x}_{0} ( n , n + 1 ) \\ {x}_{1} ( n , n + 1 ) \\ {x}_{2} ( n , n + 1 ) \\ {x}_{3} ( n , n + 1 )\end{matrix} ] = [ \begin{matrix}{s}_{0} & - {s}_{1}^{*} \\ {s}_{1} & {s}_{0}^{*} \\ {s}_{2} & - {s}_{3}^{*} \\ {s}_{3} & {s}_{2}^{*}\end{matrix} ] \qquad [ Equation 1 ]$$

In Equation 1, a matrix x(n, n+1) represents that four symbols s0, s1, s2 and s3 are transmitted for about 2 symbol times. Rows of the matrix x denote a time domain, and columns denote transmission of each antenna. A transmission apparatus 10 transmits four symbols at a first symbol time at it is. The transmitting apparatus 10 modifies phases of four symbols to be transmitted at a next symbol time, and transmits the phase modified four symbols using a transmitting antenna different from that used for transmitting the symbols at the previous symbol time.

FIG. 2 shows a configuration of an example of a receiving apparatus of a multiple-input multiple-output system.

As shown in FIG. 2, the receiving apparatus 20 includes the receiving antennas 200, CP is remover units 202, fast fourier transform (FFT) units 204, a multiple-input multiple output receiving unit 206, a deinterleaver unit 208 and a decorder unit 210.

The receiving apparatus 20 is applied to a double STBC-OFDM environment, and receives signals from the transmitting apparatus 10 through the receiving antennas 200. The MIMO system shown in FIG. 2 includes two receiving antennas 200, but the number of the receiving antennas is not limited thereto. By increasing the number of receiving antennas, additional receive diversity may be implemented.

The CP remover units 202 removes the CP from respective signals received through the receiving antenna 200. The FFT units 204 perform fast fourier transformation on the respective outputs of the CP remover units 202.

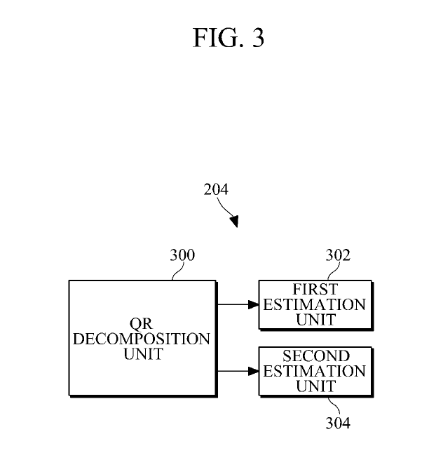

The multiple-input multiple-output receiving unit 206 performs estimation on transmitting data symbols output from the FFT unit 204, and calculates a Log Likelihood Ratio (LLR) of the estimated symbols. The details of the estimation of the symbol and calculation of LLR will be described later with reference to FIG. 3.

After that, the deinterleaver unit 208 performs deinterleaving on the signals output from the multiple-input multiple-output receiving unit 206. The decorder unit 210 decodes the deinterleaved signals to estimate transmitting data. The decoder unit 210 may be a viterbi decoder.

Hereinafter, a receiving signal processing process of the receiving apparatus 20 will be described in detail.

The receiving apparatus 20 receives and processes a receiving signal for two symbol times. The signal received for the two symbol times is expressed as Equation 2. In Equation 2, r denotes a received signal matrix and the received signal matrix is a signal after FFT is performed.

$$\begin{matrix}r = HS + n \\ = [ \begin{matrix}{h}_{00} & {h}_{01} & {h}_{02} & {h}_{03} \\ {h}_{10} & {h}_{11} & {h}_{12} & {h}_{13}\end{matrix} ] [ \begin{matrix}{s}_{0} & - {s}_{1}^{*} \\ {s}_{1} & {s}_{0}^{*} \\ {s}_{2} & - {s}_{3}^{*} \\ {s}_{3} & {s}_{2}^{*}\end{matrix} ] + [ \begin{matrix}{n}_{0} & {n}_{2} \\ {n}_{1} & {n}_{3}\end{matrix} ]\end{matrix} \qquad [ Equation 2 ]$$

As shown in FIG. 2, the receiving apparatus 20 receives a signal using two receiving antennas for two symbol times through a frequency selective fading channel. Accordingly, the received signal is expressed as a vector having two columns and two rows in Equation 2.

However, the signal received using two antennas may be expressed as a vector having four columns and one row. This is because the transmitting apparatus transmits duplicated signals although phases and positions of the transmitting antennas are changed for two symbol times. Therefore, Equation 2 is equivalently expressed as Equation 3.

$$\begin{matrix}r = Hx + n \\ = [ \begin{matrix}{h}_{00} & {h}_{01} & {h}_{02} & {h}_{03} \\ {\tilde{h}}_{01}^{*} & - {\tilde{h}}_{00}^{*} & {\tilde{h}}_{03}^{*} & - {\tilde{h}}_{02}^{*} \\ {h}_{10} & {h}_{11} & {h}_{12} & {h}_{13} \\ {\tilde{h}}_{11}^{*} & - {\tilde{h}}_{10}^{*} & {\tilde{h}}_{13}^{*} & - {\tilde{h}}_{12}^{*}\end{matrix} ] [ \begin{matrix}{s}_{0} \\ {s}_{1} \\ {s}_{2} \\ {s}_{3}\end{matrix} ] + [ \begin{matrix}{n}_{0} \\ {n}_{1} \\ {n}_{2} \\ {n}_{3}\end{matrix} ] \\ = [ \begin{matrix}{H}_{00} & {H}_{01} \\ {H}_{10} & {H}_{11}\end{matrix} ] [ \begin{matrix}{s}_{0} \\ {s}_{1} \\ {s}_{2} \\ {s}_{3}\end{matrix} ] + [ \begin{matrix}{n}_{0} \\ {n}_{1} \\ {n}_{2} \\ {n}_{3}\end{matrix} ]\end{matrix} \qquad [ Equation 3 ]$$

An equalizer eliminates a part of an effective channel matrix vector H of Equation 3.

FIG. 3 shows a detailed configuration of a multiple-input multiple-output receiving unit shown in FIG. 2.

As shown in FIG. 3, the multiple-input multiple-output receiving unit 206 includes a QR decomposition unit 300, a first estimation unit 302 and a second estimation unit 304.

The QR decomposition unit 300 performs a QR decomposition on a channel matrix vector (H) such that the channel matrix vector (H) is decomposed into a unitary matrix vector (Q) and an upper triangle matrix vector (R), and then calculates the Q matrix vector and R matrix vector. The result of QR decomposition is expressed as Equation 4. In Equation 4, QHQ is equal to 1.

$$\begin{matrix}H = [ \begin{matrix}{h}_{00} & {h}_{01} & {h}_{02} & {h}_{03} \\ {h}_{01}^{*} & - {h}_{00}^{*} & {h}_{03}^{*} & - {h}_{02}^{*} \\ {h}_{10} & {h}_{11} & {h}_{12} & {h}_{13} \\ {h}_{11}^{*} & - {h}_{10}^{*} & {h}_{13}^{*} & - {h}_{12}^{*}\end{matrix} ] \\ = [ \begin{matrix}{h}_{0} & {h}_{1} & {h}_{2} & {h}_{3}\end{matrix} ] \\ = Q \cdot R \\ = [ \begin{matrix}{q}_{00} & {q}_{01} & {q}_{02} & {q}_{03} \\ {q}_{01}^{*} & - {q}_{00}^{*} & {q}_{03}^{*} & - {q}_{02}^{*} \\ {q}_{10} & {q}_{11} & {q}_{12} & {q}_{13} \\ {q}_{11}^{*} & - {q}_{10}^{*} & {q}_{13}^{*} & - {q}_{12}^{*}\end{matrix} ] [ \begin{matrix}{R}_{00} & 0 & {R}_{02} & {R}_{03} \\ 0 & {R}_{00} & - {R}_{03}^{*} & {R}_{02}^{*} \\ 0 & 0 & {R}_{22} & 0 \\ 0 & 0 & 0 & {R}_{22}\end{matrix} ]\end{matrix} \qquad [ Equation 4 ]$$

Meanwhile, Equation 5 shows a process of calculating the Q matrix vector, and Equation 6 shows a process of calculating the Q matrix vector. The Q matrix vector and the R matrix vector are calculated using well-know methods.

$$\begin{matrix}{q}_{i 0} = {h}_{0 , i} / {‖ {h}_{0} ‖}^{2} \\ {q}_{i 2} = \frac{{h}_{2 , i} - {\sum }_{j = 0}^{1} 〈 {h}_{2} , {q}_{j} 〉 \cdot {q}_{j , i}}{{‖ {h}_{2 , i} - {\sum }_{j = 0}^{1} 〈 {h}_{2} , {q}_{j} 〉 \cdot {q}_{j , i} ‖}^{2}} \\ i ∈ \{ 0 , 1 , 2 , 3 \} & [ Equation 5 ] \\ {R}_{00} = {R}_{11} = {‖ {h}_{0} ‖}^{2} \\ {R}_{01} = 〈 {h}_{1} , {q}_{0} 〉 = 0 \\ {R}_{02} = 〈 {h}_{2} , {q}_{0} 〉 \\ {R}_{03} = 〈 {h}_{3} , {q}_{0} 〉 \\ {R}_{12} = - {〈 {h}_{2} , {q}_{0} 〉}^{*} \\ {R}_{13} = - {〈 {h}_{3} , {q}_{0} 〉}^{*} \\ {R}_{22} = {‖ {h}_{2} - {\sum }_{j = 0}^{1} 〈 {h}_{2} , {q}_{j} 〉 \cdot {q}_{j} ‖}^{2} \\ {R}_{23} = 〈 {h}_{3} , {q}_{2} 〉 = 0 \\ {R}_{33} = {R}_{22} & [ Equation 6 ]\end{matrix}$$

As shown in Equation 6, an R matrix vector R₂₃ is calculated as 0. Above features are originated from a structure of a channel matrix in a double STBC-OFDM scheme. In addition, R₃₃=R₂₂.

Meanwhile, the first estimation unit 302 estimates a predetermined symbol by use of the calculated Q matrix vector and the R matrix vector, and calculates a LLR of the estimated predetermined symbol. In order to estimate the predetermined symbol, the first estimation unit 302 performs a signal process as shown in Equation 7.

$$\begin{matrix}z = {Q}^{H} r \\ = {Q}^{H} ( Hx + n ) \\ = {Q}^{H} QRx + {Q}^{H} n \\ = Rx + {Q}^{H} n \\ = [ \begin{matrix}{R}_{00} & 0 & {R}_{02} & {R}_{03} \\ 0 & {R}_{00} & - {R}_{03}^{*} & {R}_{02}^{*} \\ 0 & 0 & {R}_{22} & 0 \\ 0 & 0 & 0 & {R}_{22}\end{matrix} ] [ \begin{matrix}{s}_{0} \\ {s}_{1} \\ {s}_{2} \\ {s}_{3}\end{matrix} ] + \\ {[ \begin{matrix}{q}_{00} & {q}_{01} & {q}_{02} & {q}_{03} \\ {q}_{01}^{*} & - {q}_{00}^{*} & {q}_{03}^{*} & - {q}_{02}^{*} \\ {q}_{10} & {q}_{11} & {q}_{12} & {q}_{13} \\ {q}_{11}^{*} & - {q}_{10}^{*} & {q}_{13}^{*} & - {q}_{12}^{*}\end{matrix} ]}^{H} [ \begin{matrix}{n}_{0} \\ {n}_{1} \\ {n}_{2} \\ {n}_{3}\end{matrix} ]\end{matrix} \qquad [ Equation 7 ]$$

As shown in Equation 7, the first estimation unit 302 applies s3 according to a predetermined constellation to find out the approximate value. For example, if the transmitting signal (s) has been processed through a 64-QAM modulation scheme (C=64), 64 complex points are applied to the Equation 7 and for finding the minimum value. Modulated signals for s₂ and s₃ are simplified as the following Equation 8.

$${\tilde{s}}_{2} = arg {min}_{{s}_{2} ∈ C} {\vert {( {Q}^{H} )}_{2} r - {R}_{22} {s}_{2} \vert}^{2} \\ {\tilde{s}}_{3} = arg {min}_{{s}_{3} ∈ C} {\vert {( {Q}^{H} )}_{3} r - {R}_{22} {s}_{3} \vert}^{2} \qquad [ Equation 8 ]$$

( )ᵢ denotes a vector corresponding to an i^{th} row. Transmitting signals s2 and s3 are estimated by Equation 8. In order to reduce implementation complexity, the first estimation unit 302 stores a result of calculating R₂₂ S₂. If the result of calculating R₂₂ S₂ is stored, it is necessary to calculate a value of R₂₂ S₃. This is because s₀, s₁, s₂ and s₃ belong to the same constellation domain. If a 2^{nd} row and a 3^{rd} column are not 0 in Equation 4, Equation 8 is not satisfied and 4096 (64×64) times of multiplications are required to estimate combination of signals s₂ and s₃ which provides a minimum value.

The first estimation unit 302 estimates combination of transmitting signals 52 and s₃ by use of a Maximum Likelihood estimate (ML estimate) through Equation 8.

After selecting s₂ and s₃ providing the minimum value based on a hard decision scheme is through Equation 8, a demapping is performed on the selected s₂ and s₃ and then the demapped value is decoded.

In order to improve signal detection performance, the first estimation unit 302 calculates an LLR corresponding to bit information of the estimated symbols s₂ and s₃ in a bit unit. The LLR value corresponding to a bit unit of s₂ and s₃ is expressed as Equation 9.

$$L L R ( {\hat{s}}_{i} , {b}_{q} ) = {min}_{{\hat{s}}_{i} ∈ {C}_{{b}_{q}}^{0}} ‖ z - R \hat{s} \vert - {min}_{{\hat{s}}_{i} ∈ {C}_{{b}_{q}}^{1}} \vert z - R \hat{s} \vert , i = 2 , 3 \qquad [ Equation 9 ]$$

In Equation 9, b_{q} denotes an LLR of a qₜₕ bit of symbol s2 and s3. C_{bq}⁰ denotes that a q^{th} bit on a constellation is 0, and C¹_{bq} denotes that a q^{th} bit on a constellation is 1. The LLR of the ŝ₂ and ŝ₃ are stored.

Meanwhile, the second estimation unit 304 estimates remaining symbols other than the estimated predetermined symbols by use of a Decision Feedback Equalizer (DFE) scheme, and calculates a LLR of the estimated remaining symbols by changing the channel matrix vector (H). The second estimation unit 304 determines ŝ₀ and ŝ₁ through DFE as shown in Equation 10. DFE is a feedback scheme used to estimate transmitting signals.

$$[ \begin{matrix}{\hat{s}}_{0} \\ {\hat{s}}_{1}\end{matrix} ] == Q [ \frac{[ \begin{matrix}{z}_{0} \\ {z}_{1}\end{matrix} ] - ( [ \begin{matrix}{R}_{02} & {R}_{03} \\ - {R}_{03}^{*} & {R}_{02}^{*}\end{matrix} ] [ \begin{matrix}{\hat{s}}_{2} \\ {\hat{s}}_{3}\end{matrix} ] )}{{R}_{00}} ] \qquad [ Equation 10 ]$$

In Equation 10, Q [ ] represents a quantization hard-decision symbol. The ML estimation provides superior performance while obtaining transmitting diversity gain through time space coding scheme, but may lead to high complexity at a receiving end. However, the ML estimation according to the present invention uses the DFE as described above, thereby reducing the complexity of the receiving end.

Meanwhile, in order to obtain the LLR of the ŝ₀ and ŝ₁, the second estimation unit 304 changes the channel matrix vector (H) and sequentially repeats Equations 4 to 10. That is, the channel matrix vector H_{SW} is modified as shown in Equation 11.

H_{sw}=[h₂h₃h₁h₀]=[\tilde{h}₀\tilde{h}₁\tilde{h}₂\tilde{h}₃] [Equation 11]

The number of Squared Euclidean distance taken for estimating symbols is 2C. As shown below in Table 1, the amount of calculating Squared Euclidean distance taken for estimating symbols is compared among different modulation scheme.

TABLE 1

| | BPSK | QPSK | 16-QAM | 64-QAM |
|---|---|---|---|---|
| CONVENTIONAL | 2⁴ | 4⁴ | 16⁴ | 64⁴ |
| ML | | | | |
| SUGGESTED ML | 2 × 2² | 2 × 4² | 2 × 16² | 2 × 64² |

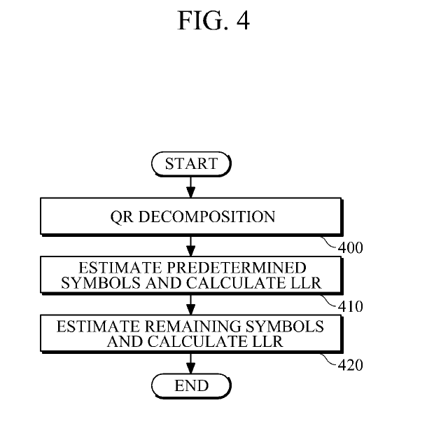

FIG. 4 shows a control flow of an example of a method of receiving signals.

As shown in FIG. 4, the multiple-input multiple-output receiving apparatus 20 converts a receiving signal into a receiving vector, and decomposes a channel matrix vector (H) of the receiving vector into a Q matrix vector and a R matrix vector (400).

Then, the receiving apparatus 20 estimates predetermined symbols by use of the Q matrix vector and the R matrix vector, and calculates an LLR of the estimated predetermined symbols (410).

After that, the receiving apparatus 20 estimates remaining symbols except for the estimated predetermined symbols by use of DFE, and calculates an LLR of the estimated remaining symbols by changing the channel matrix vector (H) (420).

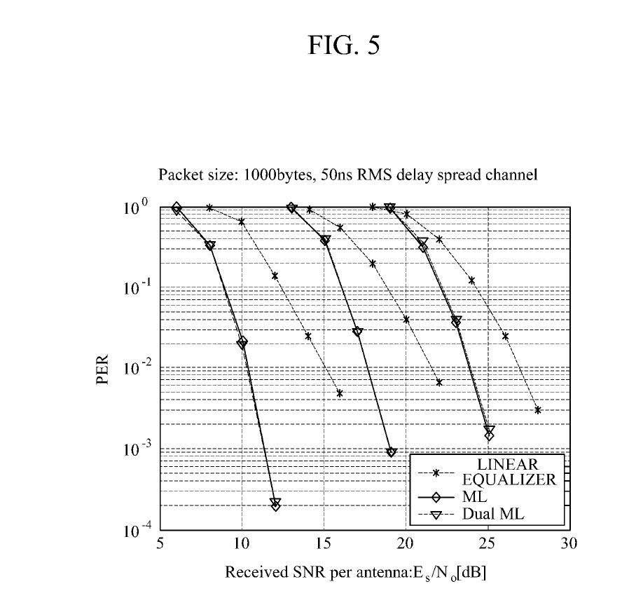

FIG. 5 shows a result of a link level simulation made when an example of a dual STBC-OFDM is used based on IEEE 802-11a Wireless Local Area Network (WLAN) standard.

In FIG. 5, the size of packet is 1000 byte, and a wireless channel corresponds to a multiple path fading channel module having 50 ns RMS delay spread. The dual STBC-OFDM (dual ML) according to the present invention provides higher gain in Signal to Noise Ratio (SNR) with the same Packet Error Rate (PER) as compared with a linear equalizer employing a conventional linear scheme. In addition, the overlapping of results of the dual STBC-OFDM (dual ML) and the conventional STBC-OFDM employing a single ML means that the dual STBC-OFDM provides the same performance as that of the conventional STBC-OFDM. However, as shown in table 1, the dual STBC-OFDM has reduced implementation complexity.

According to the method of receiving signals using the Dual STBC-OFDM, an ML-DEF technology is applied to the conventional STBC-OFDM, thereby reducing reception complexity of a receiving apparatus and improving data transfer rate. In particular, the method of receiving signals using the Dual STBC-OFDM provides superior link level performance when the number of transmitting antennas exceeds the number of receiving antennas, for example, a receiving apparatus includes four transmitting antennas and two receiving antennas. In addition, a receiving apparatus employing the method of receiving signals using the Dual STBC-OFDM has reduced implementation complexity, making it easy to use as compared with a conventional high performance receiving apparatus.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A receiving apparatus for signals using a multiple antenna in a wireless communication environment, the receiving apparatus comprising:
a QR decomposition unit configured to convert a receiving signal into a receiving vector and decompose a channel matrix vector (H) of the receiving vector into a unitary matrix vector (Q) and an upper triangle matrix vector (R);
a first estimation unit configured to estimate predetermined symbols by use of the unitary matrix vector (Q) and the upper triangle matrix vector (R) and to calculate a Log Likelihood Ratio (LLR) of the estimated predetermined symbols; and
a second estimation unit configured to estimate remaining symbols other than the predetermined symbols by use of a decision feedback equalization scheme and to calculate a Log Likelihood Ratio (LLR) of the estimated remaining symbols by switching the channel matrix vector (H) into a channel matrix vector (H_{sw}).

2. The receiving apparatus of claim 1, wherein the receiving signal is a signal coded through a double space time transmit diversity scheme in a double Space Time Block Coded-Orthogonal Frequency Division Multiplexing (STBC-OFDM) input/output environment and received while changing a phase and an antenna.

3. The receiving apparatus of claim 1, wherein the QR decomposition unit decomposes a predetermined part of the channel matrix vector by use of characteristics of the channel matrix vector which are provided when a same piece of data is repeatedly transmitted while a phase and a transmitting antenna are being changed.

4. The receiving apparatus of claim 1, wherein the first estimation unit applies complex points according to a modulation scheme to a predetermined upper triangle matrix vector to estimate, as the predetermined symbol, one providing a minimum value from the complex points.

5. The receiving apparatus of claim 4, wherein the first estimation unit stores a multiplying value of a vector value of the predetermined triangle matrix vector and a symbol value of the complex point and uses the multiplying value in estimating another symbol.

6. The receiving apparatus of claim 1, where the first estimation unit calculates a distance from one or more estimated transmitting vectors to the receiving vector which is subject to a unitary transformation with each of the estimated transmitting vectors, determines one of the estimated transmitting vectors providing a minimum distance as an optimum estimated transmitting vector and calculates a Log Likelihood Ration (LLR) of the determined optimum estimated transmitting vector.

7. The receiving apparatus of claim 1, wherein the second estimation unit estimates the remaining symbols through a hard-decision scheme.

8. The receiving apparatus of claim 1, wherein if the channel matrix vector (H) is expressed as H=[h₁h₂h₃h₄], the predetermined symbols are S2 and S3, and the remaining symbols are S0 and S1, the switched channel matrix vector (H_{sw}) is expressed as H_{sw}=[h₂h₃h₁h₀]=[\tilde{h}₀\tilde{h}₁\tilde{h}₂\tilde{h}₃].

9. An apparatus for receiving signals by use of a multiple antenna in a wireless communication environment, the apparatus comprising:
a multi-input multi-output receiving unit configured to estimate predetermined symbols by use of a maximum likelihood estimation scheme, estimate remaining symbols by use of a decision feedback equalization scheme, calculates a Log Likelihood Ratio (LLR) of each of the predetermined symbols and the remaining symbols, in which the LLR of the remaining symbol is calculated by switching a channel matrix vector (H) of the receiving signal; and
a decoding unit configured to decode the estimated predetermined symbol and the remaining symbol.

10. The apparatus of claim 9, wherein the receiving signal is a signal coded through a double space time transmit diversity scheme in a double Space Time Block Coded-Orthogonal Frequency Division Multiplexing (STBC-OFDM) input/output environment and received while changing a phase and an antenna.

11. The apparatus of claim 9, further comprising:
a cyclic prefix removing unit configured to remove a cyclic prefix (CP) code from the receiving signal;
a Fast Fourier Transform (FFT) unit configured to perform a fast fourier transform on the receiving signal from which the cyclic prefix code is removed and output the receiving signal having been subject to the fast fourier transform to the multi-input multi-output receiving unit; and
a deinterleaving unit configured to perform deinterleaving on the output from the multi-input multi-output receiving unit and provide the decoding unit with the deinterleaved output.

12. The apparatus of claim 9, wherein the multi-input multi-output receiving unit applies complex points according to a modulation scheme to a predetermined upper triangle matrix vector to estimate, as the predetermined symbol, one providing a minimum value from the complex points, stores a multiplying value of a vector value of the predetermined triangle matrix vector and a symbol value of the complex point and uses the multiplying value in estimating another symbol.

13. The apparatus of claim 9, wherein the multi-input multi-output receiving unit estimates the remaining symbols through a hard-decision scheme.

14. The apparatus of claim 9, wherein if the channel matrix vector (H) is expressed as H=[h₁h₂h₃h₄], the predetermined symbols are S2 and S3, and the remaining symbols are S0 and S1, the switched channel matrix vector (H_{sw}) is expressed as H_{sw}=[h₂h₃h₁h₀]=[\tilde{h}₀\tilde{h}₁\tilde{h}₂\tilde{h}₃].

15. A multi-input multi-output system comprising:
a transmitting apparatus configured to send signals coded through a double space time transmit diversity scheme while changing a phase and an antenna; and
a receiving apparatus configured to, if a signal is received from the transmitting apparatus, estimate predetermined symbols by use of a maximum likelihood estimation scheme, estimate remaining symbols by use of a decision feedback equalization scheme, and to calculate a Log Likelihood Ratio (LLR) of each of the predetermined symbols and the remaining symbols, in which the LLR of the remaining symbol is calculated by switching a channel matrix vector (H) of the receiving signal.

16. The multi-input multi-output system of claim 15, wherein the transmitting apparatus includes more transmitting antennas than receiving antennas of the receiving apparatus.

17. A method of receiving signals by use of a multiple antenna in a wireless communication environment, the method comprising:
converting a receiving signal into a receiving vector and decomposing a channel matrix vector (H) of the receiving vector into a unitary matrix vector (Q) and an upper triangle matrix vector (R);
estimating predetermined symbols by use of the unitary matrix vector (Q) and the upper triangle matrix vector (R);
calculating a Log Likelihood Ratio (LLR) of the estimated predetermined symbols;
estimating remaining symbols other than the predetermined symbols by use of a decision feedback equalization scheme; and
is calculating a Log Likelihood Ratio (LLR) of the estimated remaining symbols by changing the channel matrix vector (H).
